(19) United States
(12) Patent Application Publication
(10) Pub. No.: US 2025/0231343 A1
(43) Pub. Date: Jul. 17, 2025

(54) Optical Splitter, Optical Splitter Chip, Communication Device, and Optical Distribution Network

(71) Applicant: Huawei Technologies Co., Ltd., Shenzhen (CN)

(72) Inventors: Yue Wen, Shenzhen (CN); Biao Qi, Wuhan (CN); Sanxing Li, Wuhan (CN); Qian Wang, Shenzhen (CN); Wenpeng Wu, Shenzhen (CN)

(21) Appl. No.: 19/067,233

(22) Filed: Feb. 28, 2025

Related U.S. Application Data
(63) Continuation of application No. PCT/CN2023/115600, filed on Aug. 29, 2023.

(30) Foreign Application Priority Data
Sep. 2, 2022 (CN) 202211071396.X

(51) Int. Cl. G02B 6/28

(52) U.S. Cl. CPC G02B 6/2821

(57) ABSTRACT

An optical splitter includes an optical input waveguide and an optical splitting waveguide, and the optical input waveguide is configured to receive an optical signal. The optical splitting waveguide includes a first optical splitting waveguide and a plurality of second optical splitting waveguides. The first optical splitting waveguide and the second optical splitting waveguide are coplanar. The first optical splitting waveguide includes a first connection segment connected to the optical input waveguide, and the first connection segment is in a straight-line shape such that optical splitting can be disposed in a low-energy region of the optical signal.

### CROSS-REFERENCE TO RELATED APPLICATIONS

This is a continuation of International Patent Application No. PCT/CN2023/115600 filed on Aug. 29, 2023, which claims priority to Chinese Patent Application No. 202211071396.X filed on Sep. 2, 2022 which are hereby incorporated by reference in their entireties.

### TECHNICAL FIELD

This disclosure relates to the field of optical energy loss technologies of an optical splitter, and in particular, to an optical splitter, an optical splitter chip, a communication device, and an optical distribution network (ODN).

### BACKGROUND

In the field of optical communication, a splitter is a key component of an ODN communication network. In an outdoor pre-connected network scenario, a link loss is large, resulting in a short access distance and low network redundancy. A main reason is that a loss of the optical splitter is large. The loss of the optical splitter mainly includes a waveguide loss (design and process), a coupling loss between a fiber array (FA) and a waveguide, and a connector loss. Key factors for forming the waveguide loss include an optical splitting loss of branching, a waveguide bending loss, and a transmission loss.

A main reason of a branching loss is as follows: Light is transmitted in a straight waveguide in a form of fundamental mode. At a position of branching, a mode field of the fundamental mode is distorted (one branch is divided into a plurality of branches), causing a mode field mismatch and the branching loss. A main reason of the bending loss is as follows: Light is transmitted in a bent waveguide. Because the waveguide is bent, optical mode field distribution is not transmission at a center of a straight waveguide as optical mode field distribution is when light is transmitted in the straight waveguide, but is off-center energy transmission. As a result, an optical splitting ratio changes when subsequent branching continues, and energy distribution consistency of subsequent branching is poor.

Optical splitters are classified into even optical splitting and uneven optical splitting. With a continuous increase of fiber-to-the-home (FTTH) demands, a proportion of uneven optical splitting increases year by year, and demands for reducing an uneven optical splitting loss increase gradually.

### SUMMARY

This disclosure provides an optical splitter, an optical splitter chip, a communication device, and an ODN. Positions of branch waveguides are distributed, and a first optical splitting waveguide is disposed between second optical splitting waveguides, so that energy optical splitting can be disposed in a low-energy region of an optical signal. This reduces a loss generated during optical splitting of the optical signal.

According to a first aspect, this disclosure provides an optical splitter. The optical splitter includes an optical input waveguide and an optical splitting waveguide, where the optical input waveguide is configured to receive an optical signal, the optical splitting waveguide includes a first optical splitting waveguide and a plurality of second optical splitting waveguides, the first optical splitting waveguide and the second optical splitting waveguide are coplanar, and the plurality of second optical splitting waveguides is divided into two parts and located on two sides of the first optical splitting waveguide, or the plurality of second optical splitting waveguides is sequentially spaced apart along a circumferential direction of the first optical splitting waveguide, and the first optical splitting waveguide includes a first connection segment connected to the optical input waveguide, and the first connection segment is in a straight-line shape. In this disclosure, the first optical splitting waveguide is disposed between the second optical splitting waveguides, so that an optical splitting line can be effectively disposed in a low-energy region of the optical signal. This effectively reduces a branching loss of optical energy, and can balance sizes of waveguides with different optical energy ratios, to facilitate manufacturing of the optical splitter. In addition, the first optical splitting waveguide is located between the plurality of second optical splitting waveguides, and at least a part of the first optical splitting waveguide is in a straight-line shape, so that an optical signal can be efficiently transmitted, to reduce an energy loss.

In a possible implementation, a cross-sectional area of the first optical splitting waveguide is greater than a cross-sectional area of the second optical splitting waveguide, so that the first optical splitting waveguide has a large energy proportion. In addition, the first optical splitting waveguide is located between the plurality of second optical splitting waveguides, and the optical splitting line of the first optical splitting waveguide and the second optical splitting waveguide is located in the low-energy region. This reduces an energy branching loss.

In a possible implementation, the second optical splitting waveguide includes a second connection segment and a second transmission segment, the second connection segment is located between the first transition waveguide and the second transmission segment, and an optical signal sequentially flows through the second connection segment and the second transmission segment, and both the second connection segment and the second transmission segment are arc-shaped, the second connection segment bends along a transmission direction of the optical signal toward a direction away from the first optical splitting waveguide, and the second transmission segment bends along the transmission direction of the optical signal toward a direction close to the first optical splitting waveguide. The second optical splitting waveguide is of a double-arc-shaped structure, so that there is a specific gap between a light output end of the second optical splitting waveguide and a light output end of the first optical splitting waveguide, to facilitate connection to a back-end fiber and also facilitate cascading with an optical branching element to continue optical splitting.

In a possible implementation, the second connection segment and the second transmission segment are tangent at a bordering position, to ensure that the optical signal is transmitted in a smooth transition waveguide when being transmitted in the second optical splitting waveguide. This prevents an optical energy loss.

In a possible implementation, the second optical splitting segment further includes a third transmission segment, the third transmission segment is located between the second connection segment and the second transmission segment, the third transmission segment is in a straight-line shape, the third transmission segment and the second connection segment are tangent at a bordering position, and the third transmission segment and the second transmission segment are tangent at a bordering position. In this implementation, the third transmission segment is disposed as a straight-line segment, to increase a gap between the second branch waveguide and the first branch waveguide without increasing a length of a bent part in the second optical splitting waveguide, so that a large energy loss caused by a long path that is of a bent waveguide and through which an optical signal passes is avoided.

In a possible implementation, a cross-sectional area of at least a section of the second connection segment smoothly increases along the transmission direction of the optical signal, and a cross-sectional area of at least a section of the second transmission segment smoothly decreases along the transmission direction of the optical signal, to form a second optical splitting waveguide of a thin-thick-thin structure. This can effectively reduce a center deviation that occurs when an optical signal is transmitted in a bent waveguide, and improve balance of back-end optical splitting.

In a possible implementation, the second optical splitting waveguide further includes an optical branching element, the second transmission segment is cascaded with at least one optical branching element at the light output end, and all the second optical splitting waveguides in the optical splitter have N2 waveguide output ports in total, and N2 is an even number greater than or equal to 4. The light output end of the second transmission segment is cascaded with the optical branching element, so that all the second optical splitting waveguides have N2 light output ports, and energy of each light output port is the same.

In a possible implementation, the optical branching element includes a second transition waveguide and a plurality of optical branching waveguides, the optical signal enters the second transition waveguide and is split into a plurality of optical signals, and the plurality of optical signals enter the optical branching waveguides in a one-to-one manner. The optical signal enters the second transition waveguide from the second transmission segment, is split in the second transition waveguide and then enters the plurality of optical branching waveguides respectively. The optical signal is split into a plurality of balanced optical signals.

In a possible implementation, the optical branching waveguide includes a first optical splitting branch waveguide, a quantity of first optical splitting branch waveguides is two, the first optical splitting branch waveguide includes a first arc-shaped segment and a second arc-shaped segment, the first arc-shaped segment bends along a transmission direction of the optical signal toward a direction away from the other first optical splitting branch waveguide, and the second arc-shaped segment bends along the transmission direction of the optical signal toward a direction close to the other first optical splitting branch waveguide. The first optical splitting branch waveguide is of a double-arc-shaped structure, so that when the second transmission segment outputs the optical signal, the optical signal can be split and then enter the plurality of first optical splitting branch waveguides, and specific gaps exist between light output ports of the plurality of first optical splitting branch waveguides, to facilitate connection to a back-end fiber.

In a possible implementation, a cross-sectional area of at least a section of the first arc-shaped segment smoothly increases along the transmission direction of the optical signal, and a cross-sectional area of at least a section of the second arc-shaped segment smoothly decreases along the transmission direction of the optical signal. In this implementation, the first optical splitting branch waveguide is disposed in a thin-thick-thin structure. This effectively reduces a center deviation that occurs when an optical signal is transmitted in a bent waveguide, and improves balance of back-end optical splitting.

In a possible implementation, the optical branching waveguide further includes a second optical splitting branch waveguide, the second optical splitting branch waveguide is located between the two first optical splitting branch waveguides, and a section that is of the second optical splitting branch waveguide and that is connected to the second transition waveguide is in a straight-line shape. In this implementation, the second optical splitting branch waveguide is disposed, and the second optical splitting branch waveguide is disposed between the first optical splitting branch waveguides, to effectively reduce an optical splitting loss of an optical signal in the optical branching element.

In a possible implementation, the optical splitter further includes a first transition waveguide, the first transition waveguide is located between the optical input waveguide and the optical splitting waveguide, the optical signal is transmitted from the optical input waveguide into the first transition waveguide, and is split into a first optical signal and a plurality of second optical signals in the first transition waveguide, the first optical signal enters the first optical splitting waveguide, the plurality of second optical signals enter the second optical splitting waveguides in a one-to-one manner, and an energy value of the first optical signal is greater than an energy value of each second optical signal. The first transition waveguide is used to connect the optical input waveguide and the branch waveguide. The optical signal is split into the first optical signal and the second optical signal in the first transition waveguide. The first optical signal has a larger energy proportion and enters the first optical splitting waveguide, and the second optical signal has a smaller energy proportion and enters the second optical splitting waveguide.

In a possible implementation, the optical splitter further includes a substrate, the first optical splitting waveguide and the second optical splitting waveguide are both located in the substrate, and the first optical splitting waveguide and the second optical splitting waveguide are coplanar. The first optical splitting waveguide and the second optical splitting waveguide are formed in the substrate, and the first optical splitting waveguide is located between the second optical splitting waveguides, to form an uneven optical splitter in a form of planar waveguide, so that a branching loss of the optical splitter is low.

In a possible implementation, a quantity of second optical splitting waveguides is an even number, the plurality of second optical splitting waveguides is evenly divided into two parts, the two parts of the second optical splitting waveguides are mirror-symmetric to each other, and at least a section that is of the first optical splitting waveguide and that includes a light input end overlaps with a mirror axis of the second optical splitting waveguides. In this disclosure, the second optical splitting waveguides are mirror-symmetric to each other, and at least the section that is of the first optical splitting waveguide and that includes a light input end overlaps with the mirror axis of the second optical splitting waveguides, so that energy proportions of all the second optical splitting waveguides are the same.

In a possible implementation, the plurality of second optical splitting waveguides is sequentially and evenly spaced apart along the circumferential direction of the first optical splitting waveguide, and a central axis of the second optical splitting waveguides overlaps with at least a section that is of the first optical splitting waveguide and that includes a light input end. The optical splitter described in this implementation is a waveguide optical splitter in a form of fused biconical taper, the first optical splitting waveguide is located between the plurality of second optical splitting waveguides, the first optical splitting waveguide is located at an energy center of an optical splitting plane, and an optical splitting position is located in a low-energy region. This reduces an optical signal loss during optical splitting. In addition, the second optical splitting waveguides are evenly spaced apart, and at least the section that is of the first optical splitting waveguide and that includes a light input end overlaps with the central axis of the second optical splitting waveguides, so that energy proportions of all the second optical splitting waveguides are the same.

According to a second aspect, this disclosure provides an optical splitter chip. The optical splitter chip includes the optical splitter according to any one of the foregoing implementations, where the first optical splitting waveguide and the second optical splitting waveguide in the optical splitter are coplanar, and the plurality of second optical splitting waveguides is divided into two parts and located on two sides of the first optical splitting waveguide. The optical splitter chip further includes a substrate, and the first optical splitting waveguide and the second optical splitting waveguide are coplanar and located in the substrate, to form a plate-shaped optical splitter chip.

According to a third aspect, this disclosure provides a communication device. The communication device includes any one of the foregoing optical splitters, and further includes an optical line terminal (OLT), where the OLT is connected to the optical input waveguide of the optical splitter through a trunk fiber, and the OLT is configured to input an optical signal to the optical input waveguide.

According to a fourth aspect, this disclosure provides an ODN. The ODN includes any one of the foregoing optical splitters, and further includes an OLT and a plurality of optical network units (ONUs), where the OLT is connected to the optical input waveguide of the optical splitter through a trunk fiber, the OLT is configured to input an optical signal to the optical input waveguide, and the plurality of ONUs is connected to output ports of the optical splitter in a one-to-one manner through branch fibers. In the ODN according to this disclosure, in the optical splitter, the first optical splitting waveguide is disposed between the second optical splitting waveguides, so that the optical splitting line can be effectively disposed in the low-energy region of the optical signal. This effectively reduces a branching loss of optical energy, improves optical transmission efficiency of the ODN, and improves optical signal quality.

In a possible implementation, there is a plurality of optical splitters, a part of the plurality of optical splitters are level-1 optical splitters, another part of the plurality of optical splitters is level-2 optical splitters, an input port of the level-2 optical splitter is connected to an output port of the level-1 optical splitter, and the output port is an output port of the first optical splitting waveguide and/or an output port of the second optical splitting waveguide.

### BRIEF DESCRIPTION OF DRAWINGS

To describe technical solutions in some embodiments of this disclosure more clearly, the following describes the accompanying drawings used in embodiments of this disclosure.

FIG. 1 is a diagram of a structure of an optical splitter according to an implementation of this disclosure;

FIG. 2 is a diagram of optical distribution that is of an optical splitter and that is on an optical splitting plane according to an implementation of this disclosure;

FIG. 3 is a diagram of optical distribution that is of an optical splitter and that is on an optical splitting plane according to an implementation of this disclosure;

FIG. 4 is a diagram of a mode field of an optical signal before and after optical splitting according to an implementation of this disclosure;

FIG. 5 is a diagram of an uneven optical splitter in which a first optical splitting waveguide is located on a side of a second optical splitting waveguide according to an implementation of this disclosure;

FIG. 6 is a diagram of optical distribution that is of the optical splitter shown in FIG. 5 and that is on an optical splitting plane;

FIG. 7 is a diagram of an optical splitter in a form of planar waveguide according to an implementation of this disclosure;

FIG. 8 is a diagram of an internal waveguide of an optical splitter in a form of planar waveguide according to an implementation of this disclosure;

FIG. 9 is an enlarged view of I in FIG. 7;

FIG. 10 is a diagram of a 1*5 uneven optical splitter according to an implementation of this disclosure;

FIG. 11 is a diagram of an optical splitter in a form of fused biconical taper according to an implementation of this disclosure;

FIG. 12 is a diagram of optical distribution that is of an optical splitter in a form of fused biconical taper and that is on an optical splitting plane according to an implementation of this disclosure;

FIG. 13 is a diagram of a 1*4 uneven optical splitter according to an implementation of this disclosure;

FIG. 14 is a diagram of a structure of a second optical splitting waveguide according to an implementation of this disclosure;

FIG. 15 is a diagram of a structure of a second optical splitting waveguide according to an implementation of this disclosure;

FIG. 16 is a diagram of a thin-thick-thin structure of a second optical splitting waveguide according to an implementation of this disclosure;

FIG. 17 is an enlarged view of II in FIG. 16;

FIG. 18A and FIG. 18B are diagrams of optical field energy transmission of second optical splitting waveguides of a thin-thick-thin structure and of a cross-section balanced structure according to an implementation of this disclosure;

FIG. 19 is a diagram of a 1*9 uneven optical splitter according to an implementation of this disclosure;

FIG. 20 is a diagram of a structure of a 1*2 optical branching element according to an implementation of this disclosure;

FIG. 21 is a diagram of a structure of a 1*3 optical branching element according to an implementation of this disclosure;

FIG. 22 is a diagram of a communication device according to an implementation of this disclosure; and

FIG. 23 is a diagram of a structure of an ODN according to an implementation of this disclosure.

### DESCRIPTION OF EMBODIMENTS

The following describes embodiments of this disclosure with reference to the accompanying drawings in embodiments of this disclosure.

For ease of understanding, the following first explains and describes English abbreviations and related technical terms used in embodiments of this disclosure.

PON is a typical passive optical network. An ODN does not contain any electronic power supply or electronic component. The ODN includes only passive components such as splitters and does not require an expensive active electronic device. A PON includes an OLT installed at a central control station and a batch of matching ONUs installed at a user site.

FTTH is a transmission method of fiber communication. Further, FTTH means installation of an ONU at a site of a home user or an enterprise user, and is an optical access network application type closest to a user in optical access series except for fiber-to-the-desktop (FTTD).

It should be noted that the described embodiments are merely some but not all of embodiments of this disclosure. All other embodiments obtained by a person of ordinary skill in the art based on embodiments of this disclosure without creative efforts shall fall within the protection scope of this disclosure.

Terms used in embodiments of this disclosure are merely for the purpose of describing specific embodiments, but are not intended to limit this disclosure. The terms “a”, “said” and “the” of singular forms used in embodiments and the appended claims of this disclosure are also intended to include plural forms, unless otherwise specified in the context clearly.

It should be understood that the term “and/or” in this specification describes only a field for describing associated objects and represents that three relationships may exist. For example, A and/or B may represent the following three cases: only A exists, both A and B exist, and only B exists. In addition, the character “/” in this specification generally indicates an “or” relationship between the associated objects.

Depending on a context, for example, coupling of two components used herein may be understood as contact connection of the two components, or coupling of the two components may be understood as non-contact connection of the two components. This is not directly limited in this disclosure. The term “connection” used in this specification may be understood as a direct contact connection, or may be understood as an indirect connection. Descriptions of same or similar parts are omitted below.

The optical splitter described in embodiments of this disclosure is a passive component, and is also referred to as a splitter. When the optical splitter operates, power supply is not required, and optical splitting can be implemented provided that light is input. The optical splitter includes an incident slit and an emergent slit, a reflector, and a dispersion element, and is used to separate a required resonance absorption line.

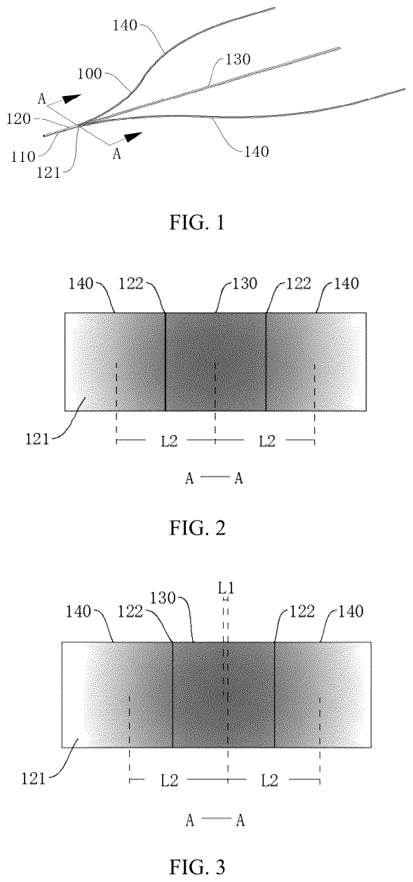

This disclosure provides an optical splitter 100. Refer to FIG. 1. The optical splitter includes an optical input waveguide 110, a first transition waveguide 120, and an optical splitting waveguide. The optical splitter may be in a form of fused biconical taper, or may be in a form of planar waveguide. In this implementation, an optical splitter in a form of planar waveguide is used as an example.

In the optical splitter in a form of planar waveguide, the optical input waveguide 110 and the optical splitting waveguide are located on a same plane. Further, the optical input waveguide 110 is configured to receive an optical signal, and input the optical signal to the first transition waveguide 120. A light output side of the first transition waveguide 120 is coupled to the optical splitting waveguide, and there is a plurality of optical splitting waveguides, to split the optical signal input by the optical input waveguide 110 into a plurality of optical signals. An optical signal is mainly transmitted in a waveguide in a form of fundamental mode. At a branch, a mode field of the fundamental mode is distorted, and one optical signal is split into a plurality of optical signals, causing a mode field mismatch and a branching loss. In addition, more branches indicate a greater loss. Each 1:2 optical splitting may generate a loss of approximately 3.5 decibel (dB).

Refer to FIG. 1. The optical splitting waveguide in this implementation includes a first optical splitting waveguide 130 and a second optical splitting waveguide 140, and there is a plurality of second optical splitting waveguides 140. In this implementation, two second optical splitting waveguides are used as an example.

Further, the optical signal input by the optical input waveguide 110 is split into one first optical signal and two second optical signals in the first transition waveguide 120, the first optical signal enters the first optical splitting waveguide 130, and the two second optical signals respectively enter the two second optical splitting waveguides 140. The first optical splitting waveguide 130 is located between the two second optical splitting waveguides 140, and the two second optical splitting waveguides 140 are located on two sides of the first optical splitting waveguide 130.

Refer to FIG. 1 and FIG. 13. The first optical splitting waveguide 130 includes a first connection segment 131 and a first transmission segment 132. The first connection segment 131 is coupled to the first transition waveguide 120, and the first connection segment 131 is in a straight-line shape. The first optical signal enters the first transmission segment 132 after passing through the first connection segment 131. The first transmission segment 132 includes one 1*2 optical splitting branch waveguide, and the 1*2 optical splitting branch waveguide is of a double-arc-shaped structure, so that after the first optical signal is split into two optical signals, an optical signal output by a light output port of the first transmission segment 132 is parallel to a transmission direction of the optical signal in the first connection segment 131. For example, the first optical splitting waveguide 130 accounts for 70% of optical energy, and the second optical splitting waveguides 140 account for 30% of the optical energy. Proportions of optical energy output by the uneven optical splitter in this implementation sequentially are 15%, 30%, 30%, and 15% from top to bottom.

Further, in this implementation, the first optical splitting waveguide 130 is not in a straight-line shape as a whole, in the first optical splitting waveguide 130, only the first connection segment 131 coupled to the first transition waveguide 120 is in a straight-line shape, and the first connection segment 131 overlaps with a central axis of the second optical splitting waveguides 140.

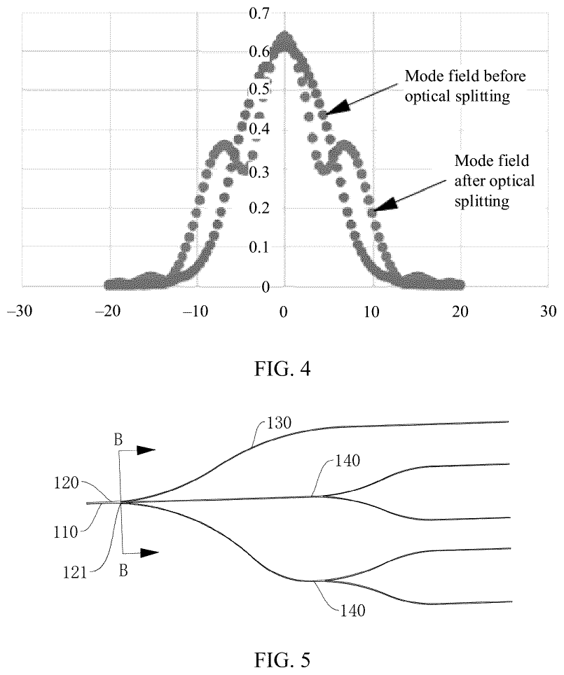

Refer to FIG. 2 and FIG. 4. FIG. 2 is a diagram in which an optical signal is split on an optical splitting plane 121. FIG. 4 is a diagram of a mode field of an optical signal before and after optical splitting. An optical signal is mainly transmitted in a waveguide in a form of fundamental mode, and presents a distribution manner in which energy gradually decreases from the middle to a surrounding outer side. In FIG. 2, a darker color corresponds to stronger optical energy. For the uneven optical splitter, energy of the first optical signal in the first optical splitting waveguide 130 is different from energy of the second optical signal in the second optical splitting waveguide 140, so that optical energy finally output by the optical splitter is not equal.

In this implementation, refer to FIG. 2. An optical splitting distance L1 of the first optical splitting waveguide 130 is less than an optical splitting distance L2 of each second optical splitting waveguide 140. In other words, the optical splitting distance L1 is less than a smaller value in the two optical splitting distances L2. An optical splitting distance is a distance between an energy center in the first transition waveguide 120 and an energy center in the optical splitting waveguide. In this implementation, an energy center of the first optical splitting waveguide 130 overlaps with an energy center of the first transition waveguide 120. Therefore, the optical splitting distance L1 of the first optical splitting waveguide 130 is 0, and is not shown in FIG. 2. The optical splitting distance of the second optical splitting waveguide 140 is L2, and a value of the optical splitting distance L2 is greater than a value of the optical splitting distance L1. When a center of the optical splitting plane 121 overlaps with the energy center in the first transition waveguide 120, the optical splitting distance may alternatively be determined by measuring a gap between a central axis of the optical splitting waveguide and the center of the optical splitting plane 121.

When an optical signal energy center in the optical splitting plane 121 deviates from the center of the optical splitting plane 121 to a specific extent, refer to FIG. 3. The optical signal energy center in the optical splitting plane 121 deviates to a specific extent to a right side relative to the center of the optical splitting plane 121. In this case, the optical splitting distance L1 of the first optical splitting waveguide 130 is less than the optical splitting distance L2 of the second optical splitting waveguide 140.

The optical splitting plane 121 described in this disclosure is a plane on which one optical signal is split into a plurality of optical signals, and an input optical signal is on a side that is of the optical splitting plane 121 and that faces the optical input waveguide 110. In this case, the optical signal is not split, and there is no optical loss. A split optical signal is on a side that is of the optical splitting plane 121 and that faces the optical splitting waveguide. In this case, the optical signal is split into three optical signals and then enters the three optical splitting waveguides respectively. Compared with that of the optical signal before optical splitting, total energy of the optical signals after optical splitting experiences an optical energy loss, and the optical energy loss mainly occurs on a branch structure of the optical splitting plane 121.

In this implementation, an optical energy proportion of the first optical splitting waveguide 130 is greater than an optical energy proportion of each second optical splitting waveguide 140, each second optical splitting waveguide 140 means every second optical splitting waveguide 140, and the optical energy proportion of the first optical splitting waveguide 130 is greater than the optical energy proportion of any second optical splitting waveguide 140. For example, the first optical splitting waveguide 130 accounts for 70% of energy, and one second optical splitting waveguide 140 accounts for 15% of the energy. A total energy sum of one first optical splitting waveguide 130 and two second optical splitting waveguides 140 is approximately 100% (in practice, an energy loss occurs, and a total energy sum is less than 100%). In this implementation, the first optical splitting waveguide 130 with a high energy proportion is disposed between the two second optical splitting waveguides 140 with a low energy proportion. Refer to FIG. 2. An optical splitting line 122 (an optical signal is split into two optical signals at the optical splitting line 122) is located in a left part region of the optical splitting plane 121, an optical energy proportion of a left side of the optical splitting line 122 is approximately 15%, the optical splitting line 122 in the left half is located in a low-energy region of the optical signal, and a branching loss is correspondingly low when optical splitting is performed herein. Similarly, another optical splitting line 122 is located in a right part region of the optical splitting plane 121, an optical energy proportion of a right side of the optical splitting line 122 is approximately 15%, the optical splitting line 122 is located in a low-energy region of the optical signal, and a branching loss is correspondingly low when optical splitting is performed herein. In addition, the first optical splitting waveguide 130 is located between the plurality of second optical splitting waveguides 140, and the first connection segment 131 that is of the first optical splitting waveguide 130 and that is connected to the optical input waveguide 110 is a straight-line segment, so that an optical signal can be efficiently transmitted, and an energy loss during optical signal transmission can be reduced, to reduce an overall energy loss of the optical splitter in correspondence to and collaboration with branching loss reduction.

It should be noted that, when the energy proportion of the first optical splitting waveguide 130 is 70%, and the energy proportion of the second optical splitting waveguide 140 is 15% in FIG. 2, because the second optical splitting waveguide 140 in the optical splitter 100 is mostly arc-shaped, and the first optical splitting waveguide 130 is mostly in a straight-line shape, the arc-shaped waveguide and the waveguide in a straight-line shape have different optical transmission efficiency and different energy losses. A deviation caused by different transmission environments is taken into account. To achieve a predetermined target output energy proportion, when optical splitting is performed on the optical splitting plane 121, a specific deviation is set for a proportion of energy directly entering each branch waveguide. Optical energy of a middle part in FIG. 2 is approximately 70%, and optical energy of the left part and the right part in FIG. 2 is approximately 15%, to balance energy loss generated by waveguides in different shapes.

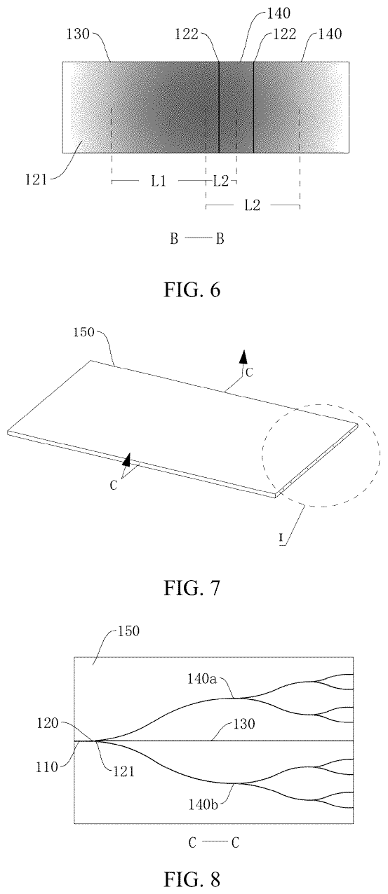

Refer to FIG. 5 and FIG. 6. The first optical splitting waveguide 130 in the optical splitter shown in FIG. 5 is located on one side of the two second optical splitting waveguides 140. One second optical splitting waveguide 140 is located between the other second optical splitting waveguide 140 and the first optical splitting waveguide 130. FIG. 6 is a diagram of optical energy distribution of the optical splitting plane 121 in an optical splitting waveguide distribution manner shown in FIG. 5. Similarly, in the distribution manner shown in FIG. 5, for example, the energy proportion of the first optical splitting waveguide 130 is 70%, and the energy proportion of one second optical splitting waveguide 140 is 15%. Refer to FIG. 6. In this distribution manner, a right-side optical splitting line 122 is close to the right-side optical splitting line 122 shown in FIG. 2, and an optical energy proportion of a right side of the right-side optical splitting line 122 is approximately 15%. However, an optical energy proportion between a left-side optical splitting line 122 and the right-side optical splitting line 122 in FIG. 6 is approximately 15%, so that the left-side optical splitting line 122 is located in a region with higher optical signal energy, and a branching loss is higher when optical splitting is performed herein. It can be learned that, in this disclosure, the first optical splitting waveguide 130 is disposed between the two second optical splitting waveguides 140, so that the optical splitting line 122 can be effectively disposed in a low-energy region of the optical signal. This effectively reduces a branching loss of optical energy.

In addition, refer to FIG. 2 and FIG. 4. According to the optical splitter 100 in this implementation, because central energy of an optical signal is high, outer side energy is low, and the center energy of the optical signal accounts for a larger proportion, when the first optical splitting waveguide 130 accounts for 70% of energy, and one second optical splitting waveguide 140 accounts for 15% of the energy, the left optical splitting line 122 and the right optical splitting line 122 are respectively located at positions at approximately one-third of the optical splitting plane 121. In this case, the first optical splitting waveguide 130 and the second optical splitting waveguide 140 have approximately equal cross-sectional areas, so that a cross section of the second optical splitting waveguide 140 in the optical splitting region is not to be excessively small, and manufacturing of the optical splitter 100 is more convenient. However, in the optical splitters shown in FIG. 5 and FIG. 6, the first optical splitting waveguide 130 and the second optical splitting waveguide 140 have a large cross-sectional size difference, and the second optical splitting waveguide 140 in the middle has a small size, which makes it difficult to manufacture the optical splitter 100.

TABLE 1
Energy table of an uneven optical splitter that includes a first optical
splitting waveguide and two second optical splitting waveguides

| | | | Insertion | | Total |
|---|---|---|---|---|---|
| Wave- | | Energy | loss/ | Total | loss/ |
| length/nm | Port | ratio | dB | energy | dB |
| 1260 | First optical | 69% | 1.61 | 96.4% | 0.159 |
| | splitting | | | | |
| | waveguide | | | | |
| | Second optical | 13.7% | 8.63 | | |
| | splitting | | | | |
| | waveguide | | | | |
| | 140a | | | | |
| | Second optical | 13.7% | 8.63 | | |
| | splitting | | | | |
| | waveguide | | | | |
| | 140b | | | | |

Refer to Table 1. For the uneven optical splitter described in this implementation, it is determined through a test that the energy proportion of the first optical splitting waveguide 130 is 69%, and an insertion loss is 1.61 dB, the energy proportion of one second optical splitting waveguide 140a in the two second optical splitting waveguides 140 is 13.7%, and an insertion loss is 8.63 dB, and the energy proportion of the other second optical splitting waveguide 140b is 13.7%, and an insertion loss is 8.63 dB. A total energy proportion of the first optical splitting waveguide 130 and the two second optical splitting waveguides 140 reaches 96.4% of the input optical signal, and approximately 3.6% of energy is lost. A total loss is 0.159 dB, and an optical energy loss is low.

In a possible implementation, refer to FIG. 7 to FIG. 9. An example in which the optical splitter is an optical splitter in a form of planar waveguide is used in this implementation. The optical splitter further includes a substrate 150, and the substrate 150 may be made of a quartz material.

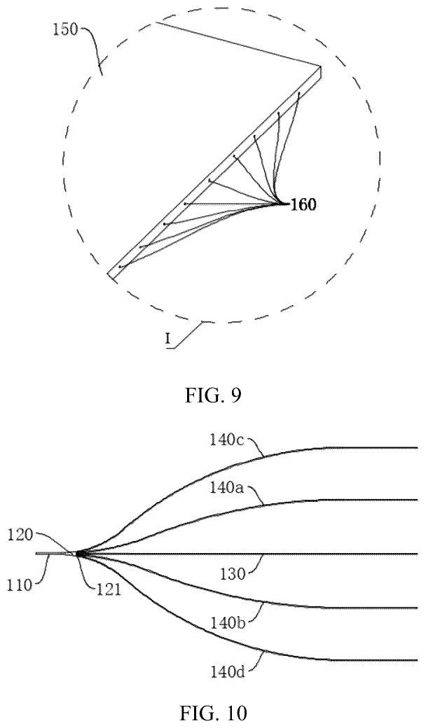

The optical input waveguide 110, the first transition waveguide 120, and the branch waveguide are waveguide paths formed in the substrate 150 by using an etching process. Further, cross sections of the optical input waveguide 110, the first transition waveguide 120, and the branch waveguide in this implementation are all squares, the optical input waveguide 110, the first transition waveguide 120, and the branch waveguide are all located in the substrate 150, the optical input waveguide 110 forms a light inlet (not shown in the figure) on one side of the substrate 150, and the branch waveguide forms a plurality of light output ends 160 on the other side of the substrate 150 (refer to FIG. 9).

A quantity N1 of the second optical splitting waveguides 140 is an even number, and may be 2, 4, 6, 8, or the like. When N1 is 2, refer to FIG. 8. Two second optical splitting waveguides 140 are respectively a second optical splitting waveguide 140a and a second optical splitting waveguide 140b, and the second optical splitting waveguide 140a and the second optical splitting waveguide 140b are respectively located on two sides of the first optical splitting waveguide 130.

When N1 is 4, refer to FIG. 10. Four second optical splitting waveguides 140 are respectively the second optical splitting waveguide 140a, the second optical splitting waveguide 140b, a second optical splitting waveguide 140c, and a second optical splitting waveguide 140d. The four second optical splitting waveguides 140 may be evenly divided into two parts, the second optical splitting waveguide 140a and the second optical splitting waveguide 140c are located on one side of the first optical splitting waveguide 130, and the second optical splitting waveguide 140b and the second optical splitting waveguide 140d are located on the other side of the first optical splitting waveguide 130. Further, the energy proportion of the first optical splitting waveguide 130 is the highest, and may be approximately 60%, energy proportions of the second optical splitting waveguide 140a and the second optical splitting waveguide 140b are lower, and may be approximately 12.5% respectively, and energy proportions of the second optical splitting waveguide 140c and the second optical splitting waveguide 140d are the lowest, and may be approximately 7.5% respectively. For the second optical splitting waveguides 140 on both sides of the first optical splitting waveguide 130, the energy proportion of the second optical splitting waveguide 140 gradually decreases along a direction away from the first optical splitting waveguide 130.

As described above, when N1 is an even number such as 8 or 10, the second optical splitting waveguides 140 may be evenly divided into two parts, and the first optical splitting waveguide 130 is located between the two parts of the evenly divided second optical splitting waveguides 140, so that the optical splitting distance L1 that is of the first optical splitting waveguide 130 and that is at the optical splitting plane 121 is less than the optical splitting distance L2 of the second optical splitting waveguide 140. This reduces an optical loss of optical splitting performed on the optical signal at the optical splitting plane 121.

In a possible implementation, refer to the optical splitters shown in FIG. 8 and FIG. 10. The N1 second optical splitting waveguides 140 are evenly divided into two parts, and the two parts of the second optical splitting waveguides 140 are mirror-symmetric to each other. The first optical splitting waveguide 130 may be a straight-line waveguide, or a section that is of the first optical splitting waveguide 130 and that is coupled to the first transition waveguide 120 is a straight-line waveguide, and the straight-line segment waveguide of the first optical splitting waveguide 130 overlaps with a mirror axis of the NI second optical splitting waveguides 140.

For a 1*3 optical splitter shown in FIG. 13, the two second optical splitting waveguides 140 are respectively the second optical splitting waveguide 140a and the second optical splitting waveguide 140b, the second optical splitting waveguide 140a and the second optical splitting waveguide 140b are respectively located on two sides of the first optical splitting waveguide 130, the first optical splitting waveguide 130 is a straight-line waveguide, and the second optical splitting waveguide 140a and the second optical splitting waveguide 140b are mirror-symmetric with respect to a straight line on which the first optical splitting waveguide 130 is located and that is used as a mirror axis. For the two second optical splitting waveguides 140 mirror-symmetric to each other, energy proportions of input optical signals entering the two second optical splitting waveguides 140 are the same, transmission statuses of the optical signals in the two second optical splitting waveguides 140 are the same, and transmission losses in the second optical splitting waveguides 140 are the same, so that energy of optical signals output by the two second optical splitting waveguides 140 is the same, to form a 1*3 uneven optical splitter (output energy proportions may be sequentially 15%, 70%, and 15%).

For a 1*5 optical splitter shown in FIG. 10, the second optical splitting waveguide 140a and the second optical splitting waveguide 140c are located on one side of the first optical splitting waveguide 130, the second optical splitting waveguide 140b and the second optical splitting waveguide 140d are located on the other side of the first optical splitting waveguide 130, and the first optical splitting waveguide 130 is a straight-line waveguide. The second optical splitting waveguide 140a and the second optical splitting waveguide 140b are mirror-symmetric with respect to the straight line on which the first optical splitting waveguide 130 is located and that is used as the mirror axis, and transmission statuses of optical signals in the second optical splitting waveguide 140a and the second optical splitting waveguide 140b are the same. The second optical splitting waveguide 140c and the second optical splitting waveguide 140d are mirror-symmetric with respect to the straight line on which the first optical splitting waveguide 130 is located and that is used as the mirror axis, and transmission statuses of optical signals in the second optical splitting waveguide 140c and the second optical splitting waveguide 140d are the same. The optical splitter in FIG. 10 forms a 1*5 uneven optical splitter (output energy proportions may be sequentially 7.5%, 12.5%, 60%, 12.5%, and 7.5%).

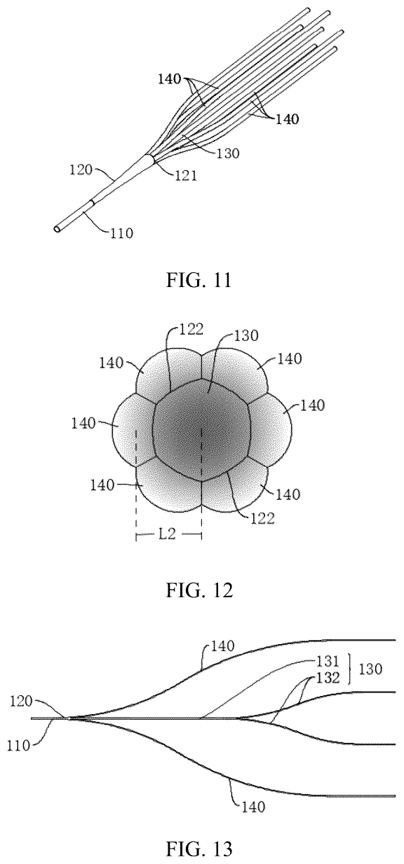

In a possible implementation, the optical splitter in this implementation may be an optical splitter in a form of fused biconical taper. Refer to FIG. 11. There is one first optical splitting waveguide 130, and the first optical splitting waveguide 130 may be in a straight-line shape. Further, when the optical splitter is an optical splitter in a form of fused biconical taper, cross sections of the optical input waveguide 110, the first transition waveguide 120, the first optical splitting waveguide 130, and the second optical splitting waveguide 140 may all be circular, there is a plurality of second optical splitting waveguides 140, and the plurality of second optical splitting waveguides 140 are sequentially spaced apart along the circumferential direction of the first optical splitting waveguide 130. In this implementation, an example in which a quantity of second optical splitting waveguides 140 is 6 is used.

Refer to FIG. 12. For an optical splitter in a form of fused biconical taper, optical energy is mostly transmitted in a form of fundamental mode, and optical energy distribution with high central energy and low outer side energy is presented. In this implementation, the first optical splitting waveguide 130 is disposed in a center of the branch waveguide, and the energy proportion of the first optical splitting waveguide 130 is higher than the energy proportion of the second optical splitting waveguide 140.

A quantity of first optical splitting waveguides 130 is 1, and a quantity of second optical splitting waveguides 140 may be 3, 4, 5, or the like. In this implementation, six second optical splitting waveguides 140 are used as an example. The energy proportion of the first optical splitting waveguide 130 may be 70%, and the energy proportion of each second optical splitting waveguide 140 may be 5%, to form 1*7 uneven optical splitter.

Further, refer to FIG. 12. A central axis of the first optical splitting waveguide 130 overlaps with the center of the optical splitting plane 121, the optical splitting distance L1 of the first optical splitting waveguide 130 is 0, and the optical splitting distance L1 of the first optical splitting waveguide 130 is not shown in the figure. The optical splitting distance L2 of the second optical splitting waveguide 140 is greater than the optical splitting distance L1 of the first optical splitting waveguide 130, the first optical splitting waveguide 130 is closer to the center of the optical signal, and the first optical splitting waveguide 130 and the second optical splitting waveguide 140 perform optical splitting in a low-energy region at an edge of the optical signal, so that an optical splitting loss is lower.

In a possible implementation, refer to FIG. 11. The plurality of second optical splitting waveguides 140 is sequentially spaced apart along the circumferential direction of the first optical splitting waveguide 130. In this implementation, one first optical splitting waveguide 130 and six second optical splitting waveguides 140 are used as an example. The first optical splitting waveguide 130 is in a straight-line shape, and the six second optical splitting waveguides 140 are of a centrosymmetric structure with respect to the straight line on which the first optical splitting waveguide 130 is located.

The six second optical splitting waveguides 140 are of the centrosymmetric structure with respect to the straight line on which the first optical splitting waveguide 130 is located, so that transmission statuses of the optical signal entering each second optical splitting waveguide 140 after optical splitting are the same, energy proportions distributed to the second optical splitting waveguides 140 are the same, and energy output by the second optical splitting waveguides 140 is also the same.

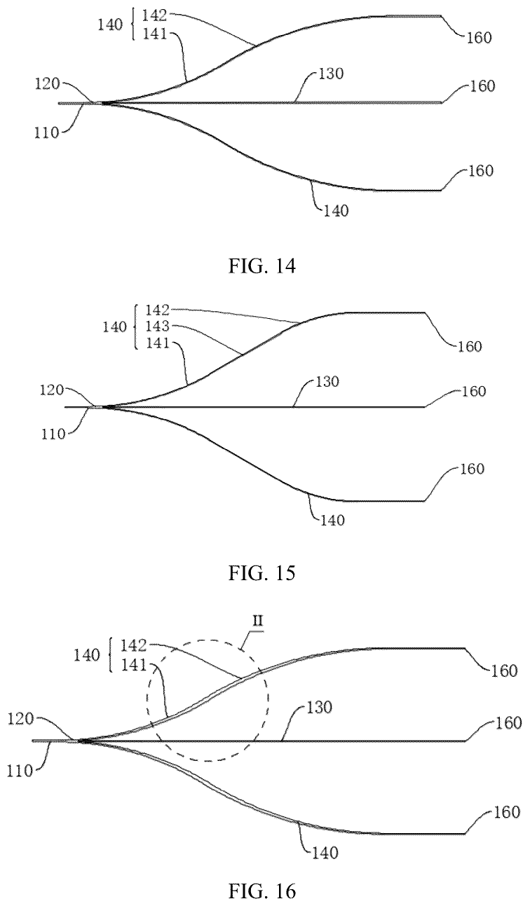

In a possible implementation, refer to FIG. 14. The second optical splitting waveguide 140 includes a second connection segment 141 and a second transmission segment 142. The second connection segment 141 is located between the first transition waveguide 120 and the second transmission segment 142. The second connection segment 141 is coupled to the first transition waveguide 120. The second connection segment 141 and the second transmission segment 142 may be two parts of one entire waveguide, or may be two connected waveguides.

The second optical signal sequentially flows through the second connection segment 141 and the second transmission segment 142. Further, both the second connection segment 141 and the second transmission segment 142 are arc-shaped, the second connection segment 141 bends along a transmission direction of the second optical signal toward the direction away from the first optical splitting waveguide 130, and the second transmission segment 142 bends along the transmission direction of the second optical signal toward a direction close to the first optical splitting waveguide 130.

Further, the second connection segment 141 and the second transmission segment 142 are tangent at a bordering position, so that when the second optical signal passes through the second connection segment 141 and the second transmission segment 142, total internal reflection can be performed on a smooth transition inner wall surface of the waveguide. This avoids an energy loss in a bordering region.

Refer to FIG. 1 and FIG. 14. After the optical signal is split into three optical signals, the three optical signals respectively enter the first optical splitting waveguide 130 and the two second optical splitting waveguides 140. Further, cross-sectional areas of the first optical splitting waveguide 130 and the second optical splitting waveguide 140 are small, and are mostly within a micrometer range.

In addition, fibers need to be connected after the first optical splitting waveguide 130 and the second optical splitting waveguide 140 through corresponding interfaces, to transmit the optical signal to a back-end device. A size of the interface is mostly within a millimeter range. Therefore, a large gap needs to exist between the light output ends 160 of the first optical splitting waveguide 130 and the second optical splitting waveguide 140, and the second optical splitting waveguide 140 needs to be bent to a specific extent to implement a specific distance between the first optical splitting waveguide 130 and the second optical splitting waveguide 140.

In addition, a bending radius of the waveguide should not be excessively small, and a bending degree of the waveguide should not be excessively large, to ensure that the optical signal is transmitted in the waveguide structure in a total internal reflection manner. This avoids an energy loss caused by refraction of the optical signal.

In addition, the second optical splitting waveguide 140 in this implementation is of a double-arc-shaped structure. After the second optical splitting waveguide bends toward the side away from the first optical splitting waveguide 130, a rear side part of the second optical splitting waveguide 140 bends toward the direction close to the first optical splitting waveguide 130, to ensure that a light output direction of the second optical splitting waveguide 140 is consistent with a light output direction of the first optical splitting waveguide 130, and fibers connected to the light output side are parallel to each other. This effectively controls a size of the optical splitter and ensures reasonableness of the structure of the optical splitter.

Further, refer to FIG. 14. The second transmission segment 142 includes the light output end 160, and a light output direction of the light output end 160 is parallel to the first connection segment 131, so that after the second optical splitting waveguide 140 deviates toward two sides of the first optical splitting waveguide 130, a transmission direction of an optical signal is not changed. The light output end 160 is an end that is of the second transmission segment 142 and that is away from the second connection segment 141.

In a possible implementation, refer to FIG. 15. The second optical splitting waveguide 140 in this implementation further includes a third transmission segment 143. The third transmission segment 143 is located between the second connection segment 141 and the second transmission segment 142, the third transmission segment 143 is a straight-line segment, the third transmission segment 143 and the second connection segment 141 are tangent at a connection point, and the third transmission segment 143 and the second transmission segment 142 are tangent at a connection point. The second connection segment 141, the second transmission segment 142, and the third transmission segment 143 may be three parts of one entire waveguide, or may be three waveguides that are sequentially connected.

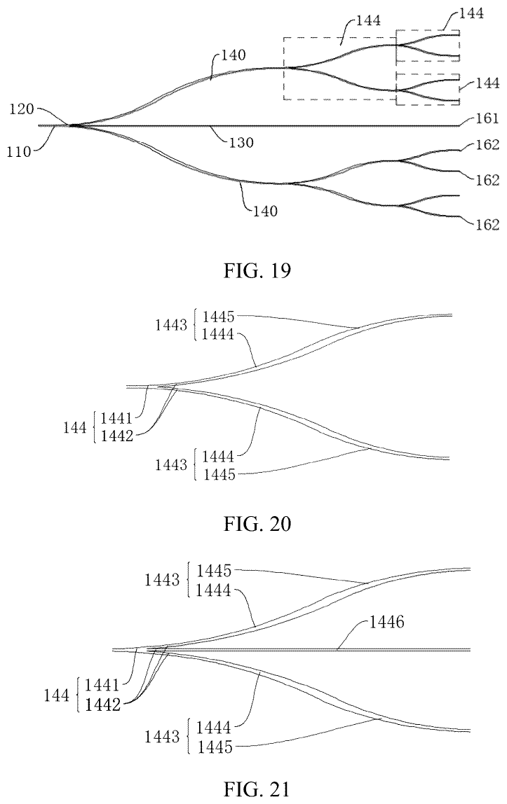

Refer to FIG. 19. When the optical splitter is a 1*9 uneven optical splitter, a back end of the second optical splitting waveguide 140 is cascaded with a plurality of optical branching waveguides. In this case, a large gap needs to be reserved between the first optical splitting waveguide 130 and the second optical splitting waveguide 140, so that the plurality of branch waveguides cascaded with the back end have sufficient space to bend and there is a specific gap between a plurality of light output ends of optical signals.

According to the optical splitter in this implementation, when the back end of the second optical splitting waveguide 140 can be cascaded with the plurality of optical branching waveguides, it can be ensured that the large gap exists between the second optical splitting waveguide 140 and the first optical splitting waveguide 130. In addition, this implementation is different from a manner in which lengths of the second connection segment 141 and the second transmission segment 142 are increased in that the third transmission segment 143 is disposed as a straight-line segment, to increase a gap between the second optical splitting waveguide 140 and the first optical splitting waveguide 130 without increasing a length of a bent part in the second optical splitting waveguide 140, so that a large energy loss caused by a long path that is of a bent waveguide and through which an optical signal passes is avoided.

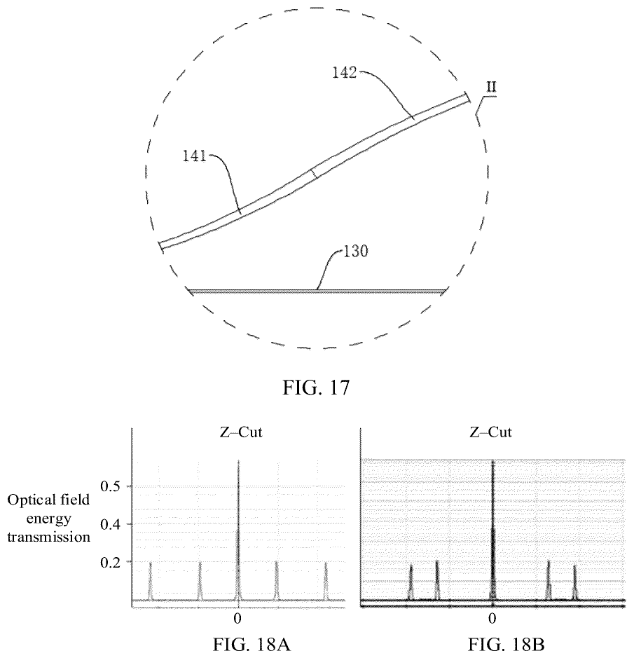

In a possible implementation, refer to FIG. 16 and FIG. 17. The second optical splitting waveguide 140 includes the second connection segment 141 and the second transmission segment 142. The second connection segment 141 is located between the first transition waveguide 120 and the second transmission segment 142. The second connection segment 141 is coupled to the first transition waveguide 120. The second connection segment 141 and the second transmission segment 142 may be two parts of one entire waveguide, or may be two connected waveguides.

The second optical signal sequentially flows through the first transition waveguide 120, the second connection segment 141, and the second transmission segment 142. Further, both the second connection segment 141 and the second transmission segment 142 are arc-shaped, the second connection segment 141 bends along the transmission direction of the second optical signal toward the direction away from the first optical splitting waveguide 130, and the second transmission segment 142 bends along the transmission direction of the second optical signal toward the direction close to the first optical splitting waveguide 130.

Further, refer to FIG. 17. A cross-sectional area of at least a section of the second connection segment 141 smoothly increases along the transmission direction of the second optical signal. In this implementation, a cross-sectional area of an overall section of the second connection segment 141 smoothly increases along the transmission direction of the second optical signal, a part that is of the second connection segment 141 and that is coupled to the first transition waveguide 120 is a thinnest part of the second connection segment 141, and a part that is of the second connection segment 141 and that is bordered to the second transmission segment 142 is a thickest part of the second connection segment 141.

Refer to FIG. 17. A cross-sectional area of at least a section of the second transmission segment 142 smoothly decreases along the transmission direction of the second optical signal. In this implementation, a cross-sectional area of an overall section of the second transmission segment 142 smoothly decreases along the transmission direction of the second optical signal, a part that is of the second transmission segment 142 and that is coupled to the second connection segment 141 is a thickest part of the second transmission segment 142, and the back-end light output end 160 of the second transmission segment 142 is a thinnest part of the second transmission segment 142.

It should be noted that a smooth increase and smooth decrease described in this disclosure means that in the increasing and decreasing process, the inner wall surface of the waveguide always has a smooth transition, no stepwise or disconnected increase and decrease occur, and inner wall surfaces of the second connection segment 141 and the second transmission segment 142 are smooth curved surfaces.

TABLE 2
Energy distribution table of a 1*9 uneven
optical splitter of a thin-thick-thin structure

| | | | Port | | |
|---|---|---|---|---|---|
| | | | insertion | Total | Total |
| Wavelength/nm | Port | Energy ratio | loss/dB | energy | loss/dB |
| 1260 | 1 | 69% | 1.61 | 95.4% | 0.213 |
| | 2 | 3.36% | 14.73 | | |
| | 3 | 3.4% | 14.68 | | |
| | 4 | 3.21% | 14.93 | | |
| | 5 | 3.23% | 14.91 | | |
| | 6 | 3.23% | 14.91 | | |
| | 7 | 3.21% | 14.93 | | |
| | 8 | 3.4% | 14.68 | | |
| | 9 | 3.36% | 14.73 | | |

The second optical splitting waveguide 140 described in this implementation is of a thin-thick-thin structure. When the second optical signal is transmitted in a bent waveguide in the second optical splitting waveguide 140, center deviation occurs due to reflection effect of the arc-shaped waveguide, and an energy center of the second optical signal deviates from a center of the second optical splitting waveguide 140. In this implementation, the second optical splitting waveguide 140 is disposed in the thin-thick-thin structure. As the cross-sectional area of the second optical splitting waveguide 140 increases, a center deviation degree of the second optical signal is correspondingly reduced, to improve optical splitting balance when optical splitting is performed at the back end of the second optical splitting waveguide 140.

Refer to Table 2. For the 1*9 uneven optical splitter, when the bent second optical splitting waveguide 140 of the 1*9 uneven optical splitter is of the thin-thick-thin structure described in this implementation, a largest energy difference between output optical energy of eight even optical splitting waveguides is less than 0.25 dB (an insertion loss of a light output port is 14.93 dB, an insertion loss of a light output port is 14.68 dB, and a largest energy deviation obtained by calculating a difference between two pieces of data is 0.25 dB). Light output balance of the optical splitter is good.

Refer to FIGS. 18A and 18B. The 1*5 uneven optical splitter in which the bent second optical splitting waveguide 140 is of the thin-thick-thin structure described in this implementation is different from an optical splitter in which a cross-sectional area of the bent second optical splitting waveguide 140 is the same in that optical energy output balance of the four even optical splitting waveguides is greatly improved, so that optical splitting balance can be effectively improved when optical splitting is performed at the back end of the second optical splitting waveguide 140. Optical field energy transmission of the optical splitter of the thin-thick-thin structure is shown in FIG. 18A, and optical field energy transmission of the optical splitter with the same cross-sectional area is shown in FIG. 18B.

In a possible implementation, refer to FIG. 19. The second optical splitting waveguide 140 in this implementation further includes an optical branching element 144, and the second transmission segment 142 is cascaded with at least one optical branching element 144 at the light output end.

Further, the optical splitter may be cascaded with a plurality of levels of optical branching elements 144 at the back end of the second optical splitting waveguide 140, and the optical branching element 144 may be a 1*2 optical branching element, or may be an optical branching element such as a 1*3, 1*4, or 1*5 optical branching element. This is further determined based on an optical splitting ratio of the optical splitter. All second optical splitting waveguides 140 in a finally formed optical splitter have N2 second waveguide output ports 162, and N2 is an even number greater than or equal to 4.

Further, in this implementation, the light output end of the second transmission segment 142 of each second optical splitting waveguide 140 is cascaded with a first-level optical branching element 144, and two branch back ends of the optical branching elements 144 are cascaded with two optical branching elements 144, to form the 1*9 uneven optical splitting waveguide shown in FIG. 19. The first optical splitting waveguide 130 has one first waveguide output port 161, and the second optical splitting waveguide 140 has eight second waveguide output ports 162. Optical energy output by the first waveguide output port 161 is different from optical energy output by the second waveguide output port 162, and optical energy output by the eight second waveguide output ports 162 is almost the same.

Further, refer to FIG. 20. The optical branching element 144 in this implementation may include a second transition waveguide 1441 and a plurality of optical branching waveguides 1442, a quantity of optical branching waveguides 1442 may be 2, 3, or 4, and two optical branching waveguides 1442 are used as an example in this implementation. The second optical signal output by the second transmission segment 142 enters the second transition waveguide 1441, and is split into a plurality of optical signals in the second transition waveguide 1441. The plurality of optical signals enters the optical branching waveguides 1442 in a one-to-one manner.

Similar to structures of the second connection segment 141 and the second transmission segment 142, the optical branching waveguide 1442 in this implementation includes a first optical splitting branch waveguide 1443, and there are two first optical splitting branch waveguides 1443. The first optical splitting branch waveguide 1443 is in an arc shape, and includes a first arc-shaped segment 1444 and a second arc-shaped segment 1445. An optical signal is sequentially transmitted through the first arc-shaped segment 1444 and the second arc-shaped segment 1445. The first arc-shaped segment 1444 bends along the transmission direction of the second optical signal toward a direction away from the other first optical splitting branch waveguide 1443, and the second arc-shaped segment 1445 bends along the transmission direction of the second optical signal toward a direction close to the other first optical splitting branch waveguide 1443, so that the two first optical splitting branch waveguides 1443 that are opposite to each other form a double-arc-shaped structure, and there is a specific gap between two light output ports of the first optical splitting branch waveguide 1443.

Further, a straight-line segment waveguide may further be added between the first arc-shaped segment 1444 and the second arc-shaped segment 1445, to increase a gap between two adjacent first optical splitting branch waveguides 1443, to ensure that a back end of the first optical splitting branch waveguide 1443 can be cascaded with another optical branching element 144.

In a possible implementation, refer to FIG. 20. A cross-sectional area of at least a section of the first arc-shaped segment 1444 smoothly increases along the transmission direction of the second optical signal. In this implementation, a cross-sectional area of an overall section of the first arc-shaped segment 1444 smoothly increases along the transmission direction of the second optical signal, a part that is of the first arc-shaped segment 1444 and that is coupled to the second transition waveguide 1441 is a thinnest part of the first arc-shaped segment 1444, and a part that is of the first arc-shaped segment 1444 and that is bordered to the second arc-shaped segment 1445 is a thickest part of the first arc-shaped segment 1444.

A cross-sectional area of at least a section of the second arc-shaped segment 1445 smoothly decreases along the transmission direction of the second optical signal. In this implementation, a cross-sectional area of an overall section of the second arc-shaped segment 1445 smoothly decreases along the transmission direction of the second optical signal, a part that is of the second arc-shaped segment 1445 and that is bordered to the first arc-shaped segment 1444 is a thickest part of the second arc-shaped segment 1445, and the light output end 160 at the back end of the second arc-shaped segment 1445 is a thinnest part of the second arc-shaped segment 1445.

The first optical splitting branch waveguide 1443 described in this implementation is of a thin-thick-thin structure. When the second optical signal is transmitted in a bent waveguide in the first optical splitting branch waveguide 1443, center deviation occurs due to reflection effect of the arc-shaped waveguide, and a center of the second optical signal deviates from a center of the first optical splitting branch waveguide 1443. In addition, as a quantity of reflection times increases, a deviation degree is more obvious. In this implementation, the first optical splitting branch waveguide 1443 is disposed in the thin-thick-thin structure, so that a quantity of reflection times of the second optical signal in the first optical splitting branch waveguide 1443 can be reduced. As the cross-sectional area of the first optical splitting branch waveguide 1443 increases, a center deviation degree of the second optical signal is correspondingly reduced, to improve optical splitting balance when optical splitting is performed at the back end of the second optical splitting waveguide 140.

In a possible implementation, refer to FIG. 21. The optical branching waveguide 1442 further includes a second optical splitting branch waveguide 1446, and the second optical splitting branch waveguide 1446 is located between the two first optical splitting branch waveguides 1443.

The second optical splitting branch waveguide 1446 may be in a straight-line shape as a whole, or a section that is of the second optical splitting branch waveguide 1446 and that is coupled to the second transition waveguide 1441 is in a straight-line shape, and a section at the back end is a non-linear waveguide such as an arc-shaped waveguide or a staggered waveguide.

At least a part of the second optical splitting branch waveguides 1446 is in a straight-line shape, and the second optical splitting branch waveguide 1446 in the straight-line shape is located between the arc-shaped first optical splitting branch waveguides 1443, which is similar to the case for the first optical splitting waveguide 130 and the second optical splitting waveguides 140. This can effectively reduce an energy loss of the second optical signal during optical splitting.

This disclosure further provides an optical splitter chip. Refer to FIG. 7 to FIG. 9. The optical splitter chip includes the optical splitter 100 according to any one of the foregoing implementations. The first optical splitting waveguide 130 and the second optical splitting waveguide 140 in the optical splitter 100 are coplanar, and the plurality of second optical splitting waveguides 140 is divided into two parts and located on two sides of the first optical splitting waveguide 130. The optical splitter chip further includes the substrate 150. The substrate 150 may be made of a quartz material.

The optical input waveguide 110, the first transition waveguide 120, and the branch waveguide are waveguide paths formed in the substrate 150 by using an etching process. Further, cross sections of the optical input waveguide 110, the first transition waveguide 120, and the branch waveguide in this implementation are all squares, the optical input waveguide 110, the first transition waveguide 120, and the branch waveguide are all located in the substrate 150, the optical input waveguide 110 forms the light inlet (not shown in the figure) on one side of the substrate 150, and the branch waveguide forms the plurality of light output ends 160 on the other side of the substrate 150 (refer to FIG. 9).

A quantity N1 of the second optical splitting waveguides 140 is an even number, and may be 2, 4, 6, 8, or the like. When N1 is 2, refer to FIG. 8. Two second optical splitting waveguides 140 are respectively the second optical splitting waveguide 140a and the second optical splitting waveguide 140b, and the second optical splitting waveguide 140a and the second optical splitting waveguide 140b are respectively located on two sides of the first optical splitting waveguide 130.

When N1 is 4, refer to FIG. 10. Four second optical splitting waveguides 140 are respectively the second optical splitting waveguide 140a, the second optical splitting waveguide 140b, the second optical splitting waveguide 140c, and the second optical splitting waveguide 140d. The four second optical splitting waveguides 140 may be evenly divided into two parts, the second optical splitting waveguide 140a and the second optical splitting waveguide 140c are located on one side of the first optical splitting waveguide 130, and the second optical splitting waveguide 140b and the second optical splitting waveguide 140d are located on the other side of the first optical splitting waveguide 130. Further, the energy proportion of the first optical splitting waveguide 130 is the highest, and may be approximately 60%, energy proportions of the second optical splitting waveguide 140a and the second optical splitting waveguide 140b are lower, and may be approximately 12.5% respectively, and energy proportions of the second optical splitting waveguide 140c and the second optical splitting waveguide 140d are the lowest, and may be approximately 7.5% respectively. For the second optical splitting waveguides 140 on both sides of the first optical splitting waveguide 130, the energy proportion of the second optical splitting waveguide 140 gradually decreases along the direction away from the first optical splitting waveguide 130.

As described above, when N1 is an even number such as 8 or 10, the second optical splitting waveguides 140 may be evenly divided into two parts, and the first optical splitting waveguide 130 is located between the two parts of the evenly divided second optical splitting waveguides 140, so that the optical splitting distance L1 that is of the first optical splitting waveguide 130 and that is at the optical splitting plane 121 is less than the optical splitting distance L2 of the second optical splitting waveguide 140. This reduces an optical loss of optical splitting performed on the optical signal at the optical splitting plane 121.

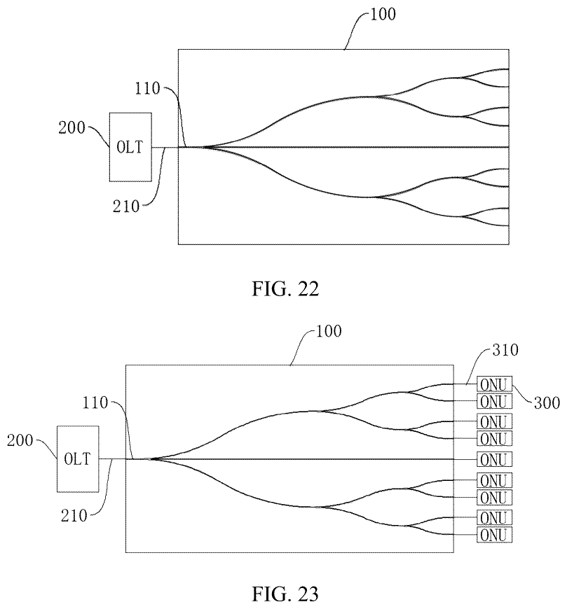

This disclosure further provides a communication device. Refer to FIG. 22. The communication device includes the optical splitter 100 according to any one of the foregoing implementations, and further includes an OLT 200. The OLT 200 is connected to the optical input waveguide 110 of the optical splitter 100 through a trunk fiber 210, and the OLT 200 is configured to input an optical signal to the optical input waveguide 110.

The OLT 200 and the optical splitter 100 may be integrated into one device, and optical signal connection is implemented inside the device through the trunk fiber 210. A plurality of output ports of the optical splitter 100 is configured to connect to the ONU 300, to implement optical signal transmission and distribution.

This disclosure further provides an ODN. Refer to FIG. 23. The ODN includes the optical splitter 100 according to any one of the foregoing implementations, and further includes an OLT 200 and a plurality of ONUs 300. The OLT 200 is coupled to the optical input waveguide 110 of the optical splitter 100 through the trunk fiber 210. The OLT 200 is configured to input an optical signal to the optical input waveguide 110. The plurality of ONUs 300 is coupled to output ports of the optical splitter 100 in a one-to-one manner through branch fibers 310.

An optical splitter is a passive device for FTTH access. It is generally used by operators in the communication industry to branch broadband on a home broadband side. Further, the optical splitter may be used in a PON system, and the system generally includes an OLT, an ODN, and an ONU. The ODN provides an optical transmission physical channel between the OLT and the ONU. The PON system in this embodiment of this disclosure may be a next-generation PON (NGPON), an NG-PON stage 1 (NG-PON1), an NG-PON stage 2 (NG-PON2), a gigabit-capable PON (GPON), a 10 gigabit per second PON (XG-PON), a 10-gigabit-capable symmetric PON (XGS-PON), an Ethernet PON (EPON), a 10 gigabit EPON (10G-EPON), a next-generation EPON (NG-EPON), wavelength-division multiplexing (WDM) PON, time-and wavelength-division multiplexing (TWDM) PON, point-to-point (P2P) WDM PON (P2P-WDM PON), an asynchronous transfer mode PON (APON), a broadband PON (BPON), or the like, and 25 gigabit per second PON (25G-PON), 50 gigabit per second PON (50G-PON), 100 gigabit per second PON (100G-PON), 25 gigabit per second EPON (25G-EPON), 50 gigabit per second EPON (50G-EPON), 100 gigabit per second EPON (100G-EPON), and various other PON systems specified by the International Telecommunication Union (ITU), or various other PON systems specified by the Institute of Electrical and Electronics Engineers (IEEE).

In the PON system, a direction from the OLT to the ONU is defined as a downlink direction, and a direction from the ONU to the OLT is defined as an uplink direction. The OLT is a core component of an optical access network, and is usually located in a central office (CO), and may manage at least one ONU in a unified manner. The OLT is configured to provide data for each accessed ONU, provide management, and the like. The OLT may be configured to send an optical signal to each ONU, receive information fed back by each ONU, and process the information fed back by the ONU, other data, or the like. The ONU is configured to receive data sent by the OLT, respond to a management command of the OLT, cache Ethernet data of a user, send data in the uplink direction in a transmit window allocated by the OLT, and so on.

The ODN generally includes an optical distribution frame (ODF), a fiber splice closure (or a splitting and splicing closure (SSC)), a fiber optical distribution box (or a fiber distribution terminal (FDT)), a fiber splitter box (or a fiber access terminal (FAT)), a fiber terminal closure (or an access terminal box (ATB)), and the like. The FDT may include an optical splitter A, and the FAT may include an optical splitter B. An optical signal from the OLT is sequentially split by the ODF, the SSC, the optical splitter A in the FDT, and the optical splitter B in the FAT, and reaches the ONU through the ATB. In other words, the optical signal from the OLT is transmitted to the ONU through an optical link between the OLT and the ONU. The optical splitter A equally divides power of a received optical signal, and one of the optical signals is transmitted to the optical splitter B through one branch. Then, the optical splitter B equally divides power of the received optical signal, and the optical signal is separately transmitted to the connected ONU through each branch. An output end of a last-level optical splitter in the ODN is used as an output port of the ODN, and the ONU is connected to the output port of the ODN.

In a possible implementation, there are a plurality of optical splitters 100 in the ODN, a part of the plurality of optical splitters 100 is level-1 optical splitters, another part of the plurality of optical splitters 100 is level-2 optical splitters, an input port of the level-2 optical splitter is connected to an output port of the level-1 optical splitter, and the output port is an output port of the first optical splitting waveguide and/or an output port of the second optical splitting waveguide.

The foregoing embodiments are merely intended for describing the technical solutions of this disclosure, but not for limiting this disclosure. Although this disclosure is described in detail with reference to the foregoing embodiments, a person of ordinary skill in the art should understand that modifications may still be made to the technical solutions described in the foregoing embodiments or equivalent replacements may be made to some technical features thereof, without departing from the spirit and scope of the technical solutions of embodiments of this disclosure, and these modifications and replacements shall fall within the protection scope of this disclosure.

1. An optical splitter, comprising:
an optical input waveguide configured to receive an optical signal; and
an optical splitting waveguide comprising:
a first optical splitting waveguide comprising a first connection segment that is coupled to the optical input waveguide and that is in a first straight-line shape; and
second optical splitting waveguides disposed in a coplanar manner with the first optical splitting waveguide and sequentially spaced apart along a circumferential direction of the first optical splitting waveguide.

2. The optical splitter of claim 1, wherein a first_ ross-sectional area of the first optical splitting waveguide is greater than a second cross-sectional area of each of the second optical splitting waveguides.

3. The optical splitter of claim 1, further comprising a first transition waveguide, wherein each of the second optical splitting waveguides comprises:
a first transmission segment having a first arc-shape and configured to bend along a transmission direction of the optical signal toward a first direction proximate to the first optical splitting waveguide; and
a second connection segment located between the first transition waveguide and the first transmission segment, having a second arc-shape, and configured to bend along the transmission direction toward a second direction away from the first optical splitting waveguide, and
wherein the second connection segment and the first transmission segment are further configured to allow the optical signal to sequentially flow through the second connection segment and the first transmission segment.

4. The optical splitter of claim 3, wherein the second connection segment and the first transmission segment are tangent at a bordering position.

5. The optical splitter of claim 3, wherein each of the second optical splitting waveguides further comprises a second transmission segment located between the second connection segment and the first transmission segment and in a second straight-line shape, wherein the second transmission segment and the second connection segment are tangent at a first bordering position, and wherein the second transmission segment and the first transmission segment are tangent at a second bordering position.

6. The optical splitter of claim 3, wherein a first cross-sectional area of a first section of the second connection segment is configured to smoothly increase along the transmission direction, and wherein a second cross-sectional area of a second section of the first transmission segment is configured to smoothly decrease along the transmission direction.

7. The optical splitter of claim 3, wherein each of the second optical splitting waveguides further comprises an optical branching element, wherein the first transmission segment is configured to cascade with the optical branching element at a light output end, wherein the second optical splitting waveguides comprise N2 waveguide output ports, and wherein N2 is an even number greater than or equal to 4.

8. The optical splitter of claim 7, wherein the optical branching element comprises a second transition waveguide and optical branching waveguides, and wherein the second transition waveguide is configured to:
input the optical signal;
split the optical signal into second optical signals; and
transmit the second optical signals into the optical branching waveguides in a one-to-one manner.

9. The optical splitter of claim 8, wherein each of the optical branching waveguides comprises two first optical splitting branch waveguides, and wherein each of the two first optical splitting branch waveguides comprises:
a first arc-shaped segment configured to bend along the transmission direction toward a third direction away from a remaining first optical splitting branch waveguide of the two first optical splitting branch waveguides; and
a second arc-shaped segment configured to bend along the transmission direction toward a fourth direction proximate to the remaining first optical splitting branch waveguide.

10. The optical splitter of claim 9, wherein a first cross-sectional area of a first section of the first arc-shaped segment is configured to smoothly increase along the transmission direction, and wherein a second cross-sectional area of a second section of the second arc-shaped segment is configured to smoothly decrease along the transmission direction.

11. The optical splitter of claim 8, wherein each of the optical branching waveguides further comprises:
two first optical splitting branch waveguides; and
a second optical splitting branch waveguide located between the two first optical splitting branch waveguides, and wherein a section that is of the second optical splitting branch waveguide and that is coupled to the second transition waveguide is in a second straight-line shape.

12. The optical splitter of claim 1, further comprising a first transition waveguide located between the optical input waveguide and the optical splitting waveguide, wherein the optical input waveguide is configured to transmit the optical signal into the first transition waveguide, and wherein the first transition waveguide is configured to:
split the optical signal into a first optical signal and second optical signals, wherein a first energy value of the first optical signal is greater than a second energy value of each of the second optical signals;
transmit the first optical signal into the first optical splitting waveguide; and
transmit the second optical signals into the second optical splitting waveguides in a one-to-one manner.

13. The optical splitter of claim 1, further comprising a substrate, and wherein the first optical splitting waveguide and the second optical splitting waveguides are located in the substrate.

14. The optical splitter of claim 13, wherein the first optical splitting waveguide comprises a section comprising a light input end, and wherein a quantity of the second optical splitting waveguides is an even number.

15. The optical splitter of claim 1, wherein the first optical splitting waveguide comprises a section comprising a light input end, wherein the second optical splitting waveguides are sequentially and evenly spaced apart along the circumferential direction, and wherein a central axis of the second optical splitting waveguides overlaps with the section.

16. An optical splitter chip, comprising:
an optical splitter comprising:
an optical input waveguide configured to receive an optical signal; and
an optical splitting waveguide comprising:
a first optical splitting waveguide comprises a connection segment coupled to the optical input waveguide and in a straight-line shape; and
second optical splitting waveguides disposed in a coplanar manner with the first optical splitting waveguide and sequentially spaced apart along a circumferential direction of the first optical splitting waveguide.

17. A communication device comprising:
an optical splitter comprising:
an optical input waveguide configured to receive an optical signal; and
an optical splitting waveguide comprising:
a first optical splitting waveguide comprising a first connection segment that is coupled to the optical input waveguide and that is in a first straight-line shape; and
second optical splitting waveguides disposed in a coplanar manner with the first optical splitting waveguide and sequentially spaced apart along a circumferential direction of the first optical splitting waveguide; and
an optical line terminal coupled to the optical input waveguide through a trunk fiber and configured to input the optical signal to the optical input waveguide.

18. The communication device of claim 17, wherein a first cross-sectional area of the first optical splitting waveguide is greater than a second cross-sectional area of each of the second optical splitting waveguides.

19. The communication device of claim 17, wherein the optical splitter further comprises a transition waveguide, and wherein each of the second optical splitting waveguides comprises:
a transmission segment having a first arc-shape and configured to bend along a transmission direction of the optical signal toward a first direction proximate to the first optical splitting waveguide; and
a second connection segment located between the transition waveguide and the transmission segment, having a second arc-shape, and configured to bend along the transmission direction toward a second direction away from the first optical splitting waveguide, and
wherein the second connection segment and the transmission segment are further configured to allow the optical signal to sequentially flow through the second connection segment and the transmission segment.

20. The communication device of claim 19, wherein the second connection segment and the transmission segment are tangent at a bordering position.
